(19) United States
(12) Patent Application Publication
(10) Pub. No.: US 2007/0194576 A1
(43) Pub. Date: Aug. 23, 2007

(54) HEAVY DUTY DOOR HANDLE AND LOCK APPARATUS

(76) Inventors: John D Esposito, Gilbert, AZ (US); Michael M. Protega, Mesa, AZ (US); Gregory E. Beaverson, Fishers, IN (US)

Correspondence Address: BARNES & THORNBURG LLP, 11 SOUTH MERIDIAN, INDIANAPOLIS, IN, 46204, US

(21) Appl. No.: 11/670,764

(22) Filed: Feb. 2, 2007

Related U.S. Application Data
(60) Provisional application No. 60/764,900, filed on Feb. 3, 2006.

(51) Int. Cl. E05C 1/06

(52) U.S. Cl. 292/143

(57) ABSTRACT

A heavy duty door handle and lock apparatus has a housing, a first handle on a first side of the housing, and a second handle on the second side of the housing. The handles are movable independently to retract a latch that extends from the housing. A lock cylinder is provided on one side of the housing. When the lock cylinder is in an unlocked position, both of the handles may be moved to retract the latch. When the lock cylinder is in a locked position, movement of one of the handles retracts the latch but movement of the other of the handles does not retract the latch.

### BACKGROUND OF THE INVENTION

The present disclosure relates to door handles and locks. More particularly, the present disclosure relates to heavy duty door handles and locks that are used in high security or institutional settings.

Schools, hospitals, manufacturing facilities, correctional facilities, and the like are experiencing higher levels of security concern. Door handles and locks in such environments are oftentimes designed to be more robust than door handles and locks used in, for example, residential housing due to increased frequency of usage and in effort to prevent vandalism and other types of security breaches. It is not unusual for door handles and locks used in these types of environments to be designed so that a person inside a building can exit even when the door is locked in a manner that otherwise prevents entry into the building from outside. Door handles and locks in institutional settings must also be compliant with the requirements of the Americans with Disabilities Act (ADA). Because of the increased robustness and requirements of heavy duty door handles and locks in institutional settings, these types of door handles and locks can be fairly complex and expensive. A heavy duty door handle and lock apparatus that is less expensive and less complex, but that still meets the more rigorous requirements of institutional facilities, may be desirable.

### SUMMARY OF THE INVENTION

The present invention comprises an apparatus having one or more of the features recited in the appended claims and/or one or more of the following features, which alone or in any combination may comprise patentable subject matter:

A door handle and lock apparatus for use with a door having generally vertically oriented front and rear surfaces is provided. The apparatus may have a housing configured to be coupled to the door. The housing may have a first wall and a second wall that is spaced from the first wall to define an interior region of the housing therebetween. A latch may be provided and may be movable along a latch axis relative to the housing between an extended position in which a portion of the latch extends from the interior region of the housing and a retracted position in which substantially all of the latch is situated in the interior region of the housing.

A first handle may extend outwardly relative to the first wall of the housing and a second handle may extend outwardly relative to the second wall of the housing. The first handle may be translatable relative to the housing along a first handle axis that is generally parallel with the latch axis. The second handle may be translatable relative to the housing along a second handle axis that is generally parallel with the latch axis. The apparatus may further have a lock that may be movable between a locking position in which the latch remains in its extended position when at least one of the first and second handles is translated relative to the housing and an unlocking position in which the latch moves from the extended position to the retracted position when at least one of the first and second handles is translated relative to the housing.

The first wall may be substantially parallel with the second wall and the housing may be configured such that, when coupled to the door, the first and second walls are substantially parallel with the front and rear surfaces of the door. The latch axis, the first handle axis, and the second handle axis may be oriented substantially horizontally when the housing is coupled to the door. The housing may include a chassis to which the first and second walls are coupled. The chassis may have a generally vertical segment which, in turn, may have a hole through which the latch extends. The chassis may also have a generally horizontal upper segment and a generally horizontal lower segment.

First and second plates may be situated between the upper and lower segments of the chassis for independent sliding movement relative to the upper and lower segments. The first handle may be coupled to the first plate and the second handle may be coupled to the second plate. The first and second handles may be generally C-shaped. Thus, each of the first and second handles may have a generally vertical gripping portion and may have generally horizontal upper and lower portions extending from the gripping portion. The first and second walls of the housing may each have a first horizontally oriented slot through which a respective upper portion may extend and a second horizontally oriented slot through which a respective lower portion may extend.

The upper and lower portions of the first and second handles may move within the first and second horizontally oriented slots when the first and second handles are translated relative to the housing, respectively. Optionally, the upper and lower portions of the first and second handles each may include flares that are sized to cover the entirety of the associated first and second horizontally oriented slots, although, when such flares are omitted, users are able to see the slots which provide visual cues to the user regarding the direction that the first and second handles should be moved to open the door.

The first and second handles may be independently moveable between respective first and second positions. The first handle may be coupled to the latch such that movement of the first handle from its first position to its second position always results in movement of the latch from the extended position to the retracted position. The second handle may be decoupled from the latch when the lock is in the locking position such that movement of the second handle from its first position to its second position does not result in movement of the latch from the extended position to the retracted position. The second handle may be coupled to the latch when the lock is in the unlocking position such that movement of the second handle from its first position to its second position results in movement of the latch from the extended position to the retracted position.

The lock may comprise a rotatable lock cylinder such as, for example, an industry standard mortise lock cylinder which locks and unlocks with a key. A first handle support may be situated in the interior region of the housing and may be coupled to the first handle for movement therewith. A second handle support may be situated in the interior region of the housing and may be coupled to the second handle for movement therewith. The first and second plates that slide relative to the chassis may serve as the first and second handle supports, respectively. A retractor hook may be coupled to the second handle support and may be movable between a first position hooked onto the latch and a second position unhooked from the latch. The rotatable lock cylinder may be rotatable to move the retractor hook between the first and second positions.

The apparatus may also have a retractor keeper that may be coupled to the second handle support. The retractor keeper may be configured to maintain the retractor in at least one of its respective first and second positions. The retractor keeper may comprise a spring.

The latch may comprise a main latch bolt oriented generally along the latch axis and a pin that may be coupled to the main latch bolt and that may be oriented generally perpendicular to the latch axis. The retractor hook may hook onto the pin when in the first position and the retractor hook may be unhooked from the pin when in the second position. An additional retractor hook coupled to the first handle support may be hooked onto the pin regardless of whether the retractor hook associated with the second handle is hooked onto, or unhooked from, the pin.

To couple the door handle and lock apparatus to a door having generally vertically oriented front and rear surfaces and generally vertically oriented first and second side surfaces, the door may be provided with a cutout extending between the front and rear surfaces and open at the first side surface. The housing may be configured to substantially fill the cutout of the door. The first and second walls of the housing may each have upper portions that extend upwardly beyond the upper segment of the chassis to define a first channel in which a first portion of the door above the cutout is trapped when the housing is coupled to the door. The first and second walls of the housing may also each have lower portions extending downwardly beyond the lower segment of the chassis to define a second channel in which a second portion of the door below the cutout is trapped when the housing is coupled to the door.

A side wall of the housing that extends between the first and second walls of the housing may have a pair of screw holes which receive screws that couple the housing to one of the side surfaces the door. The door may have notches adjacent the cutout to accommodate the side wall of the housing. The first screw hole of the pair of screw holes may open into the first channel and the second screw hole of the pair of screw holes may open into the second channel. The hole through which the latch extends from the housing may be positioned between the first and second screw holes.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a heavy duty door handle and lock apparatus according to this disclosure and a portion of a door to which the door handle and lock apparatus is coupled, the door handle and lock apparatus having a mortise lock cylinder and a C-shaped handle that is movable horizontally in a direction parallel with the door, as indicated by a first double arrow, to retract a latch of the apparatus, as indicated by a second double arrow, when the mortise lock cylinder is in an unlocking position;

FIG. 2 is a perspective view, similar to FIG. 1, showing the door handle and lock apparatus arranged for insertion into a cutout formed in the door, the door handle and lock apparatus having a housing which includes first and second side walls that define upper and lower channels in which portions of the door above and below the cutout are trapped when the apparatus is coupled, the housing having a side wall extending between the first and second walls, the door having notches adjacent the cutout to receive upper and lower portions of the side wall of the housing, and the side wall of the housing having first and second holes through which screws extend to secure the apparatus to the door;

FIG. 3 is an exploded perspective view of the door handle and lock apparatus, with portions broken away, showing the apparatus having a chassis with a generally vertical segment to which a latch bolt assembly couples, first and second plates that are retained for horizontal sliding movement between upper and lower generally horizontal segments of the chassis, the first and second handles being associated with respective first and second plates, and first and second retractor hooks that are associated with the first and second plates;

FIG. 4 is an enlarged perspective view of a portion of the door handle and lock apparatus showing the first and second retractor hooks in respective downward positions relative to the first and second plates so as to hook onto respective portions of a cross pin of the latch bolt assembly;

FIG. 5 is an enlarged perspective view, similar to FIG. 4, showing the mortise lock cylinder moved to a locking position having a cam of the mortise lock cylinder lifting one of the retractor hooks, but not the other, off of the cross pin such that movement of the associated plate to the dotted line position does not result in retraction of the latch of the latch bolt assembly;

FIG. 6 is a cross sectional view, taken along line 6-6 of FIG. 2, showing the first and second handles coupled to respective first and second plates and extending in opposite directions from the housing;

FIG. 7 is a cross sectional view, similar to FIG. 6, showing a user moving a first handles to retract the latch, the first and second handles and the associated first and second plates being movable independently such that the second handle remains stationary when the first handle is moved;

FIG. 8 is an enlarged perspective view, with portions broken away, of an alternative embodiment having a rotatable handle that is movable to rotate a gear which interfaces with a rack mounted to the associated plate to slide the plate relative to the chassis; and

FIG. 9 is a cross sectional view, taken along line 9-9 of FIG. 8, showing a shaft extending between the rotatable handle lever and the gear having a weakened neck down portion that is configured to shear or fracture in the event of an attempted forced entry.

### DETAILED DESCRIPTION OF THE DRAWINGS

A heavy duty door handle and lock apparatus 10 according to this disclosure is suitable for use in institutional facilities, such as in hospitals, schools, manufacturing facilities, military facilities, correctional facilities, and the like, but that is not to say that apparatus 10 could not be used in residential homes as well, if desired, or in other applications that are less rigorous than institutional settings. Apparatus 10 has a housing 12 that attaches to a door 14 as shown, for example, in FIG. 1. Housing 10 has first and second main walls 16, 18, as shown in FIGS. 1-3, and a side wall 20 that interconnects walls 16, 18. Wall 16 is spaced from, but substantially parallel with, wall 18 such that an interior region of housing 12 is defined between walls 16, 18.

As discussed herein, wall 16 will be considered to be associated with an interior of the building or room that door 14 opens and closes and wall 18 will be considered to be associated with an exterior of the building or room. However, this need not always be the case. When coupled to door 14, therefore, wall 18 is parallel with a front or exterior surface 22 of door 14, wall 16 is parallel with a rear or interior surface 24 of door 14, and wall 20 is parallel with first side surface 26 of door 14. The second side surface of door 14 is not illustrated herein, however, it will be appreciated that one or more door hinges will typically be mounted to door 14 on or adjacent to the second side surface and to the associated building structure as is well known in the art.

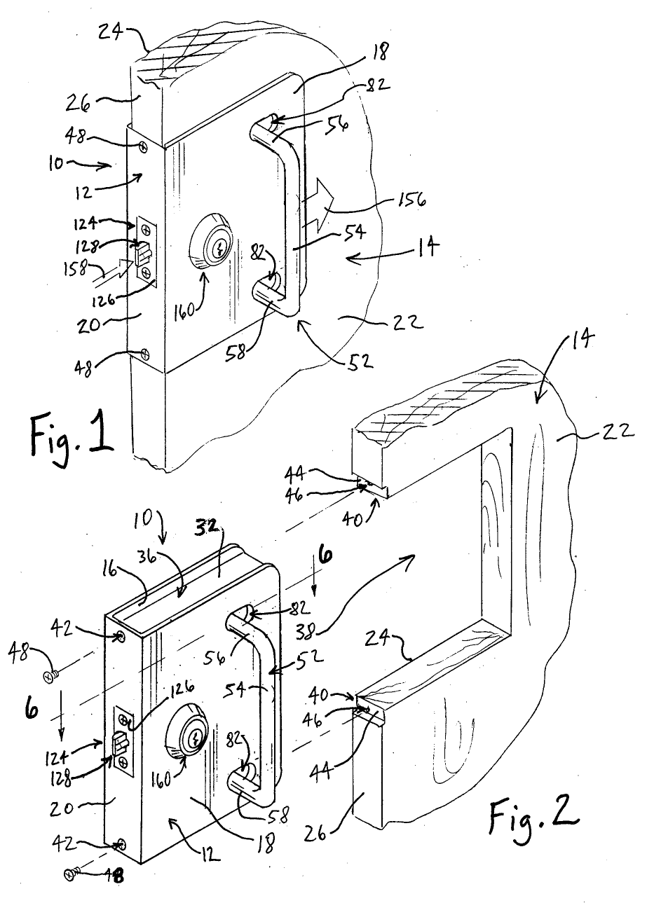

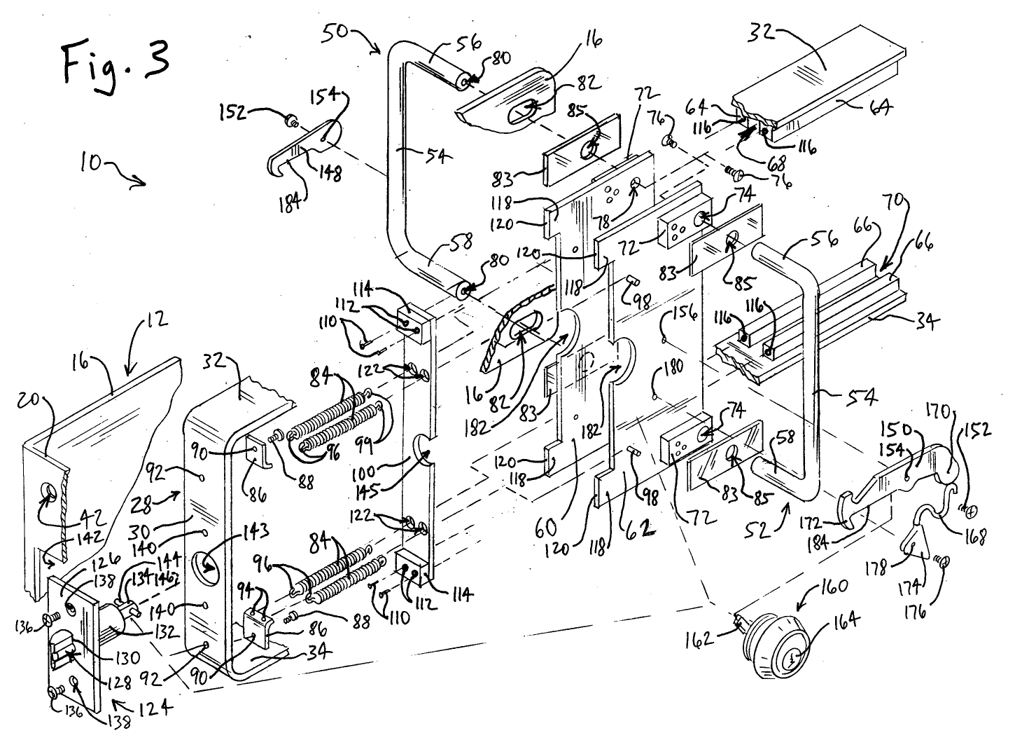

As shown in FIG. 3, apparatus 10 has a generally C-shaped chassis 28 with a generally vertical segment 30, a generally horizontal top segment 32, and a generally horizontal bottom segment 34. Segments 32, 34 extend from segment 30 in a cantilevered manner. Segment 30 is situated adjacent the inner surface of wall 20 of housing 12 and segments 32, 34 extend therefrom within the interior region of housing 12 between walls 16, 18. However, the top regions of walls 16, 18, 20 extend upwardly beyond segment 32 of chassis 28 and the bottom regions of walls 16, 18, 20 extend downwardly beyond 34 of chassis 28. Thus, top and bottom channels 36 are defined between the top and bottom regions of walls 16, 18, respectively, with one channel 36 being above segment 32 of chassis 28, as shown in FIG. 2, and the other channel 36 being below segment 34.

To accommodate apparatus 10 in door 14, a large cutout 38 is formed in door 14 as shown in FIG. 2. Cutout 38 is open at surface 26 of door 14 and extends between surfaces 22, 24 of door 14. Cutout 38 is sized so that, when apparatus 10 is mounted to door 14, a portion of door 14 above cutout 38 is received in the channel 36 which overlies segment 32 of chassis 28 and a portion of door 14 beneath cutout 38 is received in the channel 36 which underlies segment 34 of chassis 34. Thus, portions of door 14 are trapped in channels 36 between walls 16, 18 of housing 12. A pair of notches 40 are formed in door 14 at the point where cutout 38 meets side surface 26 of door 14 such that one notch 40 is above cutout 38 and the other notch 40 is below cutout 38. Cutouts 40 are sized to receive upper and lower portions of wall 20 of housing 12 therein having the outer surface of wall 20 generally coplanar with edge 26 of door 14.

The upper and lower portions of wall 20 of housing 12 have screw-receiving apertures 42 formed therethrough as shown in FIG. 2. Generally vertical surfaces 44 of door 14, which bound notches 40, each have screw-receiving holes 46 formed therein as shown in FIG. 2. Apertures 42 in wall 20 are in communication with respective channels 36. A pair of screws 48 extend through apertures 42 and are threaded into holes 46 to secure door handle and lock apparatus 10 to door 14. By having screws 48 located along wall 20 of housing 12 in this manner, it will be appreciated that when door 14 is in the closed position, screws 48 are inaccessible.

Referring now to FIG. 3, apparatus 10 has a first or interior door handle 50 and a second or exterior door handle 52. Each handle has a generally vertical segment or portion 54, a generally horizontal upper segment or portion 56, and a generally horizontal lower segment or portion 58. In the illustrative example, portions 56, 58 meet with portion 54 to form rounded corners at the top and bottom of portion 54 and portions 56, 58 extend from portion 54 in a cantilevered manner. Apparatus 10 also has an interior or first paddle or plate 60 and an exterior or second paddle or plate 62. Plates 60, 62 are generally vertically oriented and extend practically the full distance between top and bottom segments 32, 34 of chassis 28 with a slight amount of clearance being provided between plates 60, 62 and chassis 28 to permit plates to translate or slide relative to chassis 28. Optionally, anti-friction elements such as polymeric glides pads or linear bearings or the like (not shown) may be provided at the interface between plates 60, 62 and chassis 28 to reduce the friction between plates 60, 62 and chassis 28.

A pair of upper rails 64 are coupled to the undersurface of top segment 32 of chassis 28 and a pair of lower rails 66 are coupled to the upper surface of bottom segment 34 of chassis 28 as shown in FIG. 3. Rails 64 are spaced apart to define an upper channel 68 within which an upper portion of plates 60, 62 are received and rails 66 are spaced apart to define a lower channel 70 within which a lower portion of plates 60, 62 are received. Thus, plates 60, 62 are retained in chassis 28 by rails 64, 66 but are permitted to translate independently relative to chassis 28 toward and away from vertical segment 30 of chassis 28. In the illustrative example, the spacing between rails 64 and between rails 66 is such that plates 60, 62 fit therein with only a slight amount of clearance. Optionally, anti-friction elements may be placed between plates 60, 62 and rails 64, 66 and/or optionally, anti-friction spacers may be provided between plates 60, 62 to prevent plates 60, 62 from rubbing together during movement of one of plates 60, 62 relative to the other. Such spacers may be mounted to one or both of plates 60, 62 and/or to segments 32, 34 so as to project from segments between plates 60, 62.

A pair of handle retainers 72 are coupled to each of plates 60, 62 as shown in FIG. 3 with regard to plate 62. One of retainers 72 is situated near the top of the respective plate 60, 62, but below an overlying rail 64, and the other of retainers 72 is situated near the bottom of the respective plate 60, 62, but above the underlying rail 66. In the illustrative example, retainers 72 are in the form of blocks which are fastened to plates 60, 62 by dowel pins, although other types of couplers such as adhesive, welds, screws, rivets, and the like may be used in lieu of dowel pins. Each retainer 72 has a hole 74 that receives an end of either portion 56 of the respective handle 50, 52, in the case of the upper retainers 72, or portion 58 of the respective handle 50, 52, in the case of the lower retainers 72.

In the illustrative example, a set of screws 76 extend through respective holes 78 formed in plates 60, 62 and are threaded into holes 80 provided in the distal ends of portions 56, 58 of handles 50, 52 to couple handles to plates 60, 62. Thus, in the illustrative example, retainers 74 serve to reinforce the connection between handles 50, 52 and plates 60, 62. In other embodiments, handles 50, 52 may be fastened to plates 60, 62 via set screws that extend through blocks 72, such as from the end of blocks 72, into engagement with respective portions 56, 58 of handles 50, 52. If a lesser amount of reinforcement is desired for handles 50, 52, such as to reduce weight or cost of apparatus 10, then retainers 72 may be omitted leaving only screws 74 to provide the means for coupling handles 50, 52 to plates 60, 62. Other means for fastening handles 50, 52 to plates 60, such as welding, adhesive, C-rings, cotter pins, rivets, press fit between handles 50, 52 and retainers 72, press fit between handles 50, 52 and plates 60, 62, or the like are within the scope of this disclosure.

As shown in FIGS. 1-3, walls 16, 18 of housing 12 are provided with horizontally oriented, elongated slots 82 which receive respective portions 56, 58 of handles 50, 52 therein. Thus, handles 50, 52 may be moved horizontally in a direction parallel with front and rear surfaces 22, 24 of door 14 by a distance dictated by the length of slots 82. Of course, plates 60, 62 move relative to chassis 28 when handles 50, 52 are moved in this manner. A cover 83, which in the illustrative embodiment is a thin sheet of metal material, such as aluminum having a thickness of about 1 millimeter, is coupled to each retainer 72 to block access to the interior region of apparatus 10 through portions of slots 82 that are unoccupied by segments 56, 58 of handles 50, 52. Holes 85 are provided in each cover 83 and segments 56, 58 pass through respective holes 85 into holes 74 of retainers 72. In other embodiments, retainers 74 may be longer and slightly thicker so as to suitably block access to the interior region of apparatus 10 through slots 82, in which case, covers 83 may be omitted.

A set of biasing springs 84 are provided to bias plates 60, 62 and the respective handles 50, 52 toward segment 30 of chassis 28, and consequently, toward wall 20 of housing 12. A pair of bent tabs 86 are coupled to segment 30 of chassis 28 by suitable couplers, such as illustrative screws 88, which extend through an aperture 90 in each tab 86 into threaded engagement with a corresponding threaded aperture 92 formed in segment 30. Each tab 86 has a pair of apertures 94 and each aperture 94 receives a respective hook 96 provided at one of end of a corresponding spring 84. A pair of vertically spaced apart dowel pins 98 project from respective plates 60, 62 and a respective hook 99 provided at an opposite end of each spring 84 is hooked onto a corresponding dowel pin 98.

Illustrative springs 84 are coil springs that are maintained in a state of tension between tabs 86 and dowel pins 98 so as to provide a perpetual bias of plates 60, 62 and handles 50, 52 toward segment 30 of chassis 28. A stop 100, in the form of a bar in the illustrative example, extends vertically between segments 32, 34 of chassis. Stop 100 is coupled to ends of rails 64, 66 by suitable couplers, such as screws 110 which extend through apertures 112 provided through stop 100 and through reinforcement blocks 114 provided at the top and bottom of stop 100 into threaded engagement with threaded holes 116 provided in ends of rails 64, 66. Plates 60, 62 each have a pair of vertically spaced, horizontally extending projections 118 with edges 120 that engage stop 100 to limit the movement of respective plates 60, 62 toward segment 30 of chassis 28. When plates 60, 62 are move by handles 50, 52 away from segment 30 of chassis 28 and away from wall 20 of housing 12, edges 120 separate away from stop 100. Stop 100 has four holes 122 through which respective springs 84 extend. Springs 84 are relatively tightly wound and receipt of springs in holes 122 helps to prevent hooks 99 from slipping laterally off of dowel pins 98.

Apparatus 10 includes a latch bolt assembly 124 which, in turn, includes a mounting plate 126, a latch 128 extending forwardly through a latch aperture 130 formed in plate 126, a latch cylinder 132 extending rearwardly from plate 126, and a latch bolt 134 that extends rearwardly out of cylinder 132. Assembly 124 is mounted to segment 30 of chassis 28 by suitable couplers, such as illustrative screws 136 that extend through respective apertures 138 in plate 126 into threaded engagement with threaded holes 140 provided in segment 30 of chassis 28. A rectangular hole 142, a portion of which is shown in FIG. 3, is formed in front wall 20 of housing 12 and plate 126 is situated in hole 142 such that the outer surface of plate 126 and the outer surface of wall 20 are generally coplanar as shown, for example, in FIGS. 1 and 2. A fairly large hole 143 is formed in segment 30 of chassis 28 and cylinder 132 extends through hole 143 when latch assembly 124 is coupled to segment 30. Stop 100 also has a hole or cutout 145 through which cylinder 132 extends. Thus, when latch assembly 124 is coupled to segment 30, cylinder 132 and latch bolt 134 are situated in the interior region of housing 12.

Latch assembly 124 also includes a cross member 144 that is coupled to latch bolt 134 and that extends perpendicular to latch bolt 134 as shown in FIG. 3. In the illustrative example, member 144 is a roll pin. A spring or other biasing member (not shown) is provided in cylinder 132 to bias latch 128 to an extended position as shown in FIGS. 1-6. However, latch 128 is movable along a generally horizontal latch axis 146 from the extended position to a retracted position in which substantially all of latch 128 is retracted into cylinder 132 as shown, for example, in FIG. 7. When door 14 is closed and latch 128 is in the extended position, latch 128 is received in an aperture in a complementary member, plate, or other structure 147 that is coupled to, or part of, the associated doorjamb 146 as shown in FIG. 6 (in phantom). Receipt of latch 128 in the associated complementary structure 147 maintains door 14 in the closed position.

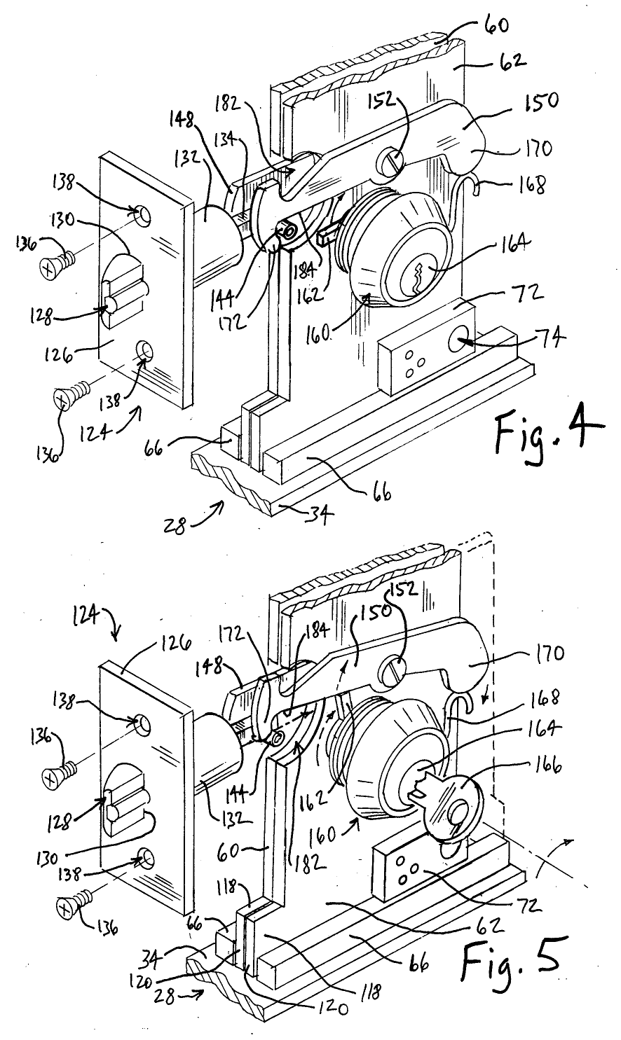

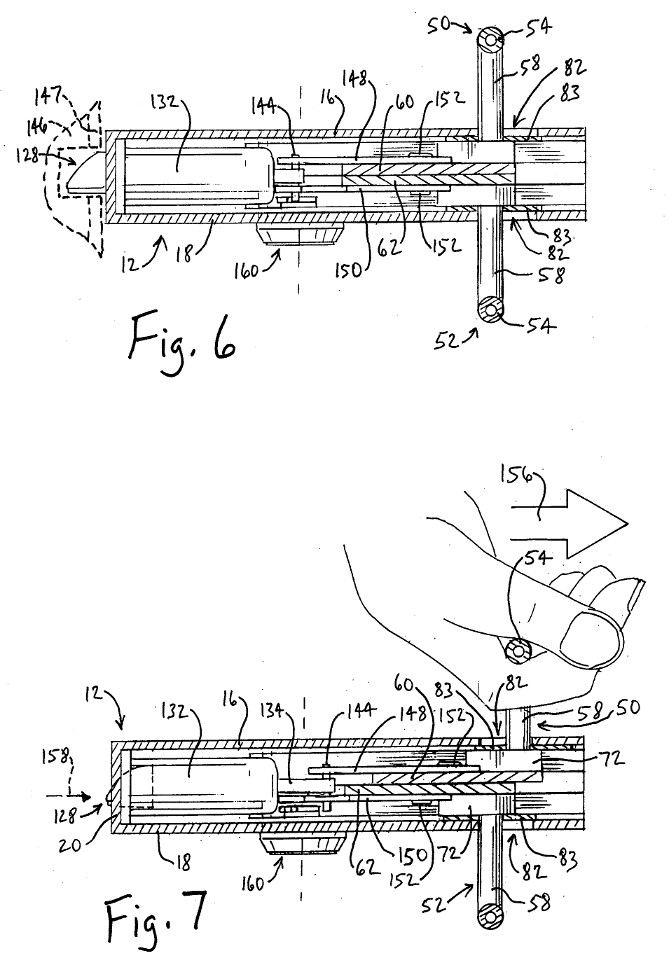

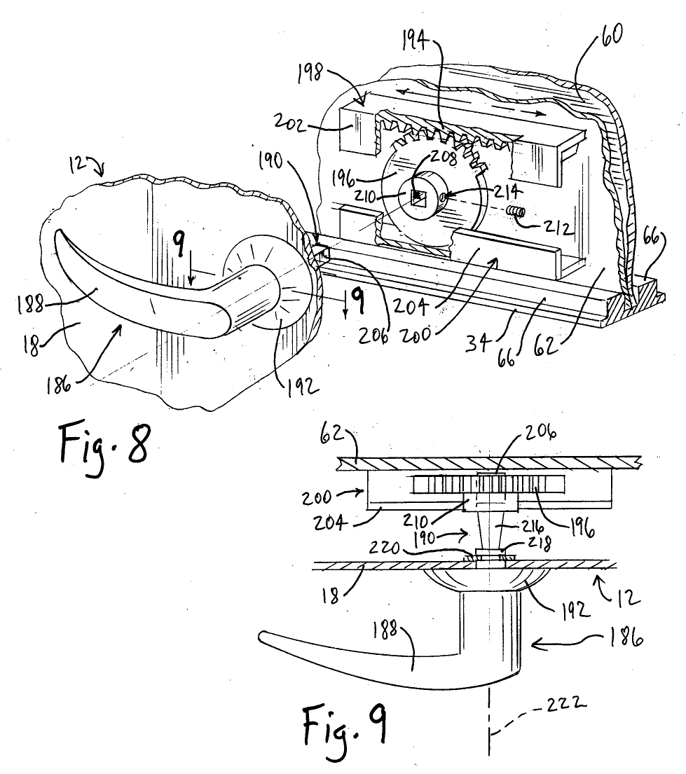

Apparatus 10 includes a first retractor hook 148 and a second retractor hook 150 as shown in FIGS. 3-5. Hooks 148, 150 are coupled to plates 60, 62, respectively, by suitable fasteners, such as illustrative screws 152, shown best in FIG. 3, that extend through respective apertures 154 in hooks 148, 150 and that are threaded into threaded holes 156 provided in plates 60, 62. Hook 148 hooks onto a first portion of cross member 144, which extends toward interior wall 16 of housing 12, whereas hook 150, when apparatus 10 is unlocked, hooks onto a second portion of cross member 144 which extends toward exterior wall 18 of housing 12 as shown in FIG. 4. Thus, when hooks 148, 150 are both hooked onto respective portions of member 144, either of handles 50, 52 can be moved from respective first positions, shown in FIG. 6, to respective second positions in the direction of arrow 156, shown in FIG. 1 with respect to handle 52 and shown in FIG. 7 with respect to handle 50, to move the associated plates 60, 62 and hooks 148, 150 which, in turn, pull on cross member 144 thereby resulting in latch bolt 134 pulling latch 128 from the extended position to the retracted position as indicated by arrow 158 in FIGS. 1 and 7.

In the illustrative example, the hook 154 that is coupled to interior plate 60 is always hooked onto the respective portion of cross member 144 and therefore, users are able to move the interior handle 50 in direction 156 to retract latch 128 in direction 158 to open door 14 in order to exit the associated room or building at all times. However, the hook 150 that is coupled to exterior plate 62 is movable from a lowered position, shown in FIG. 4, to a raised position, shown in FIG. 5, unhooked from the respective portion of cross member 144 to prevent use of exterior handle 52 from opening the door 14. A standard mortise lock cylinder 160 is included in apparatus 10 and has a cam 162 that is coupled to a lock core 164 to rotate between locked and unlocked positions along with core 164 when core 164 is turned with a key 166 as shown in FIG. 5.

Apparatus 10 has a spring 168 that engages a back end portion 170 of hook 150 to bias hook 150 about coupler 152 toward the lowered or unlocked position. Thus, when lock cylinder 164 is rotated to the unlocked position, spring 168 forces hook 150 from the raised position down to the lowered position having a front end portion 172 of hook 150 hooked onto cross member 144 as shown in FIG. 4. When core 164 is moved to the locked position, cam 162 engages the bottom edge of hook 150 and overcomes the bias of spring 168 to lift hook 150 off of cross member 144 as shown in FIG. 5. When hook 150 is lifted off of cross member 144 to its raised or locked position, shown in FIG. 5, movement of handle 52 in direction 156 does not result in retraction of latch 128 in direction 158 because front end portion 172 of hook 150 passes above cross member 144 without grabbing it, thereby leaving door locked in the closed position.

In the illustrative example, spring 168 is fashioned as a wavy wire that is flexed downwardly by back end portion 170 of hook 150. The wavy wire of spring 168 extends from a tab 174 which is coupled to plate 62 by a suitable coupler such as a screw 176 which passes through an aperture 178 in tab 174 and threads into a threaded hole 180 formed in plate 62 as shown in FIG. 3. In other embodiments, a torsion spring may be provided to bias hook 150 toward the lowered or unlocked position in lieu of spring 168. Such a torsion spring may be mounted on coupler 152 and may have a first end that is fixed relative to plate 62 and a second end that engages hook 150. In still other embodiments, a coil spring may be used in lieu of spring 168. Depending upon where such a coil spring is connected to hook 150 and depending upon whether the coil spring is above or below hook, the coils spring may be maintained in a state of tension or compression to provide the biasing force to hook 150.

In some embodiments, a biasing spring, similar to any of those described above, may also be provided to maintain hook 148 in its position hooked onto cross member 144. It should be appreciated, that hook 148 may be rigidly attached to plate 60, if desired, because it does not need to be able to lift off of cross member 144. However, it within the scope of this disclosure for a lock cylinder to be provided on the interior side, either in addition to lock cylinder 160 or in lieu of lock cylinder 160 on the exterior side of apparatus 10, such that hook 148 may be moved between locked and unlocked positions in a manner substantially similar to the manner in which hook 150 is moved between its locked and unlocked positions as described above.

Regardless of whether handle 50 or handle 52 is used to retract latch 128, cross member 144 moves away from segment 30 of chassis 28 when latch 128 is retracted. To accommodate this movement of cross member 144, each of plates 60, 62 has a cutout 182 in which cross member 144 is received when latch 128 is in the retracted position. Because plates 60, 62 are movable independently relative to chassis 28, when handle 50 is used to retract latch 128, handle 52 and plate 62 remain stationary, and when handle 52 is used to retract latch 128, handle 50 and plate 60 remain stationary. Hooks 148, 150 are shaped so as to allow cross member 144 to move away from the “hooked” front end portions thereof when the associated plate 60, 62 remains stationary during movement of the other plate 60, 62. This provides a lost motion connection between hooks 148, 150 and cross member 144. In the illustrative embodiment, cross members 144 slide along a straight bottom edge region 184 of the stationary one of hooks 148, 150 when the other of hooks 148, 150 is pulling cross member 144 in direction 156. Of course, if hook 148 is in the unlocked position, then the straight bottom edge region 184 of hook 148 is spaced from cross member 144 due to hook 148 being lifted off of cross member 144.

In the illustrative example, all elements of apparatus 10 are made from a metal material, such as steel or aluminum. However, components of apparatus 10 may be made from any materials having suitable strength characteristics. If desired, housing 12 may be made from hardened steel to make drilling into the interior region of housing 12 difficult. Optionally, plates 60, 62 may be made of a polymeric material to enhance the ability of plates 60, 62 to slide relative to chassis 28. It should be appreciated that apparatus 10 provides a heavy duty door handle and lock solution but uses a readily available, industry standard latch bolt assembly 124 and a readily available, industry standard mortise lock cylinder 160.

Referring now to FIGS. 8 and 9, an alternative embodiment of apparatus 10 having a rotatable handle 186 is shown. Although only one rotatable handle 186 is shown in FIGS. 8 and 9, it should be appreciated that rotatable handles 186 may be provided on the exterior and interior sides of apparatus 10 in lieu of handles 50, 52. Thus, the description below of one of handles 186 is equally applicable to the handle 186 on the opposite of apparatus 10. Furthermore, other than the differences between handles 50, 52 and handles 186, all other portions of apparatus 10 remain the same. Accordingly, like reference numerals are used in FIGS. 8 and 9 to denote portions of the alternative embodiment that are substantially similar to apparatus 10 shown in FIGS. 1-7.

Rotatable handle 186 includes a lever 188 and a shaft 190 which extends from lever 188 through wall 18 of housing 12. A decorative escutcheon 192 at the interface between lever 188 and the outer surface of wall 18. A toothed rack 194 is coupled to plate 62 and a toothed gear or pinion 196 meshes with rack 194 as shown in FIG. 8. Rack 194 is included as part of an upper rail 198 which has an L-shaped cross section. A lower rail 200 having an L-shaped cross section is coupled to plate 62 vertically beneath rail 198. Gear 196 is trapped between rails 198, 200. In particular, a downwardly extending vertical wall 202 of rail 198 and an upwardly extending vertical wall 204 of rail 200 prevent gear 196 from separating away from wall 62.

Shaft 190 has an end portion 206 with a square-shaped cross section that is received in a square-shaped hole 208 formed in a cylindrical hub 210 of gear 196. A set screw 212 is threaded through a threaded hole 214 in hub 210 into engagement with portion 206 of shaft 190 to couple handle 186 to gear 196. Shaft 190 has a tapered portion 216 that necks down from portion 206 in a direction toward lever 188. Shaft 190 also has an annular shoulder portion 218 which has a larger diameter than the adjacent end of necked down portion 216. A C-ring 220 is mounted to shaft 190 between shoulder portion 218 and wall 18 to further couple handle 186 to housing 12 as shown in FIG. 9.

When lever 188 of handle 186 is rotated about a handle axis 222, which passes through shaft 190, gear 196 also rotates resulting in translation of rack 194 relative to gear 196 which, in turn, causes plate 62 to translate relative to chassis 28 because rack 194 is coupled to plate 62. If the hook 148 coupled to plate 62 is in the unlocked position hooked onto cross member 144, then rotation of lever 188 in this manner results in the retraction of latch 128. When lever 188 is released, springs 84 pull plate 62 back toward its original position, along with rack 194 which results in rotation of gear 196 thereby returning handle 186 back to its original position.

Neck down portion 216 provides a weakened area of shaft 190 which is intended to fracture if a threshold amount of force is applied to lever 188 during an attempted forced entry. The materials used and the diameter of the small end of the necked down portion 216 will dictate the amount of force needed on lever 188 to cause a fracture. Portion 216 can be designed, for example, so that the threshold force is about 400 pounds, but can be designed to provide a different amount of threshold force above or below 400 pounds. If shaft 190 fractures during a forced entry, gear 196 and the broken portion of shaft 190 attached thereto, is prevented from falling away from plate 62 by rails 198, 200 thereby preventing the potential of interfering with the operation of other portions of apparatus 10.

Although certain illustrative embodiments have been described in detail above, variations and modifications exist within the scope and spirit of this disclosure as described and as defined in the following claims.

1. A door handle and lock apparatus for use with a door having generally vertically oriented front and rear surfaces, the apparatus comprising
a housing configured to be coupled to the door, the housing having a first wall and a second wall that is spaced from the first wall to define an interior region of the housing therebetween,
a latch movable along a latch axis relative to the housing between an extended position in which a portion of the latch extends from the interior region of the housing and a retracted position in which substantially all of the latch is situated in the interior region of the housing,
a first handle extending outwardly relative to the first wall of the housing, the first handle being translatable relative to the housing along a first handle axis that is generally parallel with the latch axis,
a second handle extending outwardly relative to the second wall of the housing, the second handle being translatable relative to the housing along a second handle axis that is generally parallel with the latch axis, and
a lock movable between a locking position in which the latch remains in its extended position when at least one of the first and second handles is translated relative to the housing and an unlocking position in which the latch moves from the extended position to the retracted position when at least one of the first and second handles is translated relative to the housing.

2. The apparatus of claim 1, wherein the first wall is substantially parallel with the second wall and the housing is configured such that, when coupled to the door, the first and second walls are substantially parallel with the front and rear surfaces of the door.

3. The apparatus of claim 1, wherein the latch axis, the first handle axis, and the second handle axis are oriented substantially horizontally when the housing is coupled to the door.

4. The apparatus of claim 1, wherein the housing includes a chassis to which the first and second walls are coupled.

5. The apparatus of claim 4, wherein the chassis comprises a generally vertical segment having a hole through which the latch extends.

6. The apparatus of claim 4, wherein the chassis comprises a generally horizontal upper segment and a generally horizontal lower segment, further comprising first and second plates situated between the upper and lower segments for independent sliding movement relative to the upper and lower segments, the first handle being coupled to the first plate, and the second handle being coupled to the second plate.

7. The apparatus of claim 1, wherein the first and second handles are generally C-shaped, each of the first and second handles having a generally vertical gripping portion and having generally horizontal upper and lower portions extending from the gripping portion, the first and second walls each having a first horizontally oriented slot through which a respective upper portion extends, and each of the first and second walls having a second horizontally oriented slot through which a respective lower portion extends.

8. The apparatus of claim 7, wherein the upper and lower portions of the first and second handles move within the first and second horizontally oriented slots when the first and second handles are translated relative to the housing.

9. The apparatus of claim 7, wherein the upper and lower portions of the first and second handles each include flares that are sized to cover the entirety of the associated first and second horizontally oriented slots.

10. The apparatus of claim 1, wherein the first and second handles are independently moveable between respective first and second positions, the first handle is coupled to the latch such that movement of the first handle from its first position to its second position always results in movement of the latch from the extended position to the retracted position, the second handle being decoupled from the latch when the lock is in the locking position such that movement of the second handle from its first position to its second position does not result in movement of the latch from the extended position to the retracted position, and the second handle being coupled to the latch when the lock is in the unlocking position such that movement of the second handle from its first position to its second position results in movement of the latch from the extended position to the retracted position.

11. The apparatus of claim 1, wherein the lock comprises a rotatable lock cylinder.

12. The apparatus of claim 11, further comprising a first handle support situated in the interior region of the-housing and coupled to the first handle for movement therewith, a second handle support situated in the interior region of the housing and coupled to the second handle for movement therewith, and a retractor hook coupled to the second handle support and movable between a first position hooked onto the latch and a second position unhooked from the latch, and wherein the rotatable lock cylinder is rotatable to move the retractor hook between the first and second positions.

13. The apparatus of claim 12, wherein the housing further comprises a chassis, the first handle support comprises a first plate that slides relative to the chassis, and the second handle support comprises a second plate that slides relative to the chassis.

14. The apparatus of claim 12, further comprising a retractor keeper coupled to the second handle support and configured to maintain the retractor in its respective first and second positions.

15. The apparatus of claim 12, wherein the latch comprises a main latch bolt oriented generally along the latch axis and a pin that is coupled to the main latch bolt and that is oriented generally perpendicular to the latch axis, the retractor hook hooking onto the pin when in the first position, and the retractor hook being unhooked from the pin when in the second position.

16. The apparatus of claim 11, wherein the rotatable lock cylinder comprises a threaded mortise cylinder which is configured for receipt of a key.

17. A door handle and lock apparatus for use with a door having generally vertically oriented front and rear surfaces, generally vertically oriented first and second side surfaces, and a cutout extending between the front and rear surfaces and open at the first side surface, the apparatus comprising
a housing configured to substantially fill the cutout of the door, the housing having a first wall that is generally parallel with the front surface of the door and a second wall that is generally parallel with the rear surface of the door, the housing having an interior region between the first and second walls,
a latch movable relative to the housing between an extended position in which a portion of the latch extends from the interior region of the housing and a retracted position in which substantially all of the latch is situated in the interior region of the housing,
a first handle extending outwardly relative to the first wall of the housing,
a second handle extending outwardly relative to the second wall of the housing, and
a lock movable between a locking position in which the latch remains in its extended position when at least one of the first and second handles is moved relative to the housing and an unlocking position in which the latch moves from the extended position to the retracted position when at least one of the first and second handles is moved relative to the housing.

18. The apparatus of claim 17, wherein the housing comprises a chassis having a generally horizontal upper segment and a generally horizontal lower segment, the first and second walls each having upper portions extending upwardly beyond the upper segment of the chassis to define a first channel in which a first portion of the door above the cutout is trapped when the housing is coupled to the door, and the first and second walls each having lower portions extending downwardly beyond the lower segment of the chassis to define a second channel in which a second portion of the door below the cutout is trapped when the housing is coupled to the door.

19. A door handle and lock apparatus for use with a door having generally vertically oriented front and rear surfaces, generally vertically oriented first and second side surfaces, and a cutout extending between the front and rear surfaces and open at the first side surface, the apparatus comprising
a housing configured to be received in the cutout and coupled to the door, the housing having a first wall, a second wall that is spaced from the first wall to define an interior region of the housing therebetween, and a side wall extending between the first and second walls, the side wall having a latch receiving opening,
a latch extending through the latch receiving opening and movable relative to the housing between an extended position in which a portion of the latch extends from the interior region beyond the side wall of the housing and a retracted position in which substantially all of the latch is situated in the interior region of the housing,
a first handle extending outwardly relative to the first wall of the housing,
a second handle extending outwardly relative to the second wall of the housing, and
a lock movable between a locking position in which the latch remains in its extended position when at least one of the first and second handles is moved relative to the housing and an unlocking position in which the latch moves from the extended position to the retracted position when at least one of the first and second handles is moved relative to the housing, the side wall of the housing having a pair of screw holes which receive screws that couple the housing to the door.

20. The apparatus of claim 19, wherein the housing comprises a chassis having a generally horizontal upper segment and a generally horizontal lower segment, the first and second walls each having upper portions extending upwardly beyond the upper segment of the chassis to define a first channel, a first screw hole of the pair of screw holes opening into the first channel, the first and second walls each having lower portions extending downwardly beyond the lower segment of the chassis to define a second channel, and a second screw hole of the pair of screw holes opening into the second channel.
